(19) United States
(12) Patent Application Publication
(10) Pub. No.: US 2011/0048810 A1
(43) Pub. Date: Mar. 3, 2011

(54) SYNERGIC SURFACE MODIFICATION FOR BEARING SEAL

(75) Inventors: Chih Lin, Spring, TX (US); Aaron J. Dick, Houston, TX (US)

(73) Assignee: Baker Hughes Incorporated, Houston, TX (US)

(21) Appl. No.: 12/548,238

(22) Filed: Aug. 26, 2009

(51) Int. Cl. E21B 10/25; F16J 15/16; B23P 25/00

(52) U.S. Cl. 175/371; 277/500; 29/458

(57) ABSTRACT

The present invention relates to a method and apparatus for forming a dynamic seal between two surfaces. More specifically, the invention relates to creating a textured surface with a thin, hard coating on a metallic annular sealing ring such as the sealing ring used in an earth boring drill bit.

### BACKGROUND OF THE INVENTION

1. Field of the Invention

The present invention relates generally to drill bits for drilling into a subterranean formation, and more specifically to a thin, textured wear-resistant coating on seals used within the drill bit.

2. Description of Related Art

The success of rotary drilling enabled the discovery of deep oil and gas reservoirs. The rotary rock bit was an important invention that made the success of rotary drilling possible. Only soft earthen formations could be penetrated commercially with the earlier drag bit, but the two-cone rock bit, invented by Howard R. Hughes, U.S. Pat. No. 930,759, drilled the hard cap rock at the Spindletop Field, near Beaumont, Tex. with relative ease. That venerable invention, within the first decade of this century, could drill a scant fraction of the depth and speed of the modern rotary rock bit. If the original Hughes bit drilled for hours, the modern bit drills for days. Modern bits sometimes drill for thousands of feet instead of merely a few feet. Many advances have contributed to the impressive improvement of earth-boring bits of the rolling cutter variety.

In drilling boreholes in earthen formations by the rotary method, earth-boring bits typically employ at least one rolling cone cutter, rotatably mounted thereon. The bit is secured to the lower end of a drillstring that is rotated from the surface or by downhole motors. The cutters mounted on the bit roll and slide upon the bottom of the borehole as the drillstring is rotated, thereby engaging and disintegrating the formation material. The rolling cutters are provided with teeth that are forced to penetrate and gouge the bottom of the borehole by weight from the drillstring.

As the cutters roll and slide along the bottom of the borehole, the cutters, and the shafts on which they are rotatably mounted, are subjected to large static loads from the weight on the bit, and large transient or shock loads encountered as the cutters roll and slide along the uneven surface of the bottom of the borehole. Thus, most earth-boring bits are provided with precision-formed journal bearings and bearing surfaces, as well as sealed lubrication systems to increase drilling life of bits. The lubrication systems typically are sealed to avoid lubricant loss and to prevent contamination of the bearings by foreign matter such as abrasive particles encountered in the borehole. A pressure compensator system minimizes pressure differential across the seal so that lubricant pressure is equal to or slightly greater than the hydrostatic pressure in the annular space between the bit and the sidewall of the borehole.

Early Hughes bits had no seals or rudimentary seals with relatively short life, and, if lubricated at all, necessitated large quantities of lubricant and large lubricant reservoirs. Typically, upon exhaustion of the lubricant, journal bearing and bit failure soon followed. An advance in seal technology occurred with the “Belleville” seal, as disclosed in U.S. Pat. No. 3,075,781, to Atkinson et al. The Belleville seal minimized lubricant leakage and permitted smaller lubricant reservoirs to obtain acceptable bit life.

An adequately sealed journal-bearing bit should have greater strength and load-bearing capacity than an anti-friction bearing bit. The seal disclosed by Atkinson would not seal lubricant inside a journal-bearing bit for greater than about 50-60 hours of drilling, on average. This was partially due to rapid movement of the cutter on its bearing shaft (cutter wobble), necessitated by bearing and assembly tolerances, which causes dynamic pressure surges in the lubricant, forcing lubricant past the seal, resulting in premature lubricant loss and bit failure.

The O-ring, journal bearing combination disclosed in U.S. Pat. No. 3,397,928, to Galle unlocked the potential of the journal-bearing bit. Galle's O-ring-sealed, journal-bearing bit could drill one hundred hours or more in the hard, slow drilling of West Texas. The success of Galle's design was in part attributable to the ability of the O-ring design to help minimize the aforementioned dynamic pressure surges.

A major advance in earth-boring bit seal technology occurred with the introduction of a successful rigid face seal. The rigid face seals used in earth-boring bits are improvements upon a seal design known as the “Duo-Cone” seal, developed by Caterpillar Tractor Co. of Peoria, Ill. Rigid face seals are known in several configurations, but typically comprise at least one rigid ring, having a precision seal face ground or lapped and polished thereon, confined in a groove near the base of the shaft on which the cutter is rotated, and an energizer member, which urges the seal face of the rigid ring into sealing engagement with a second seal face. Thus, the seal faces mate and rotate relative to each other to provide a sealing interface between the rolling cutter and the shaft on which it is mounted.

The combination of the energizer member and rigid ring permits the seal assembly to move slightly to minimize pressure fluctuations in the lubricant, and to prevent extrusion of the energizer past the cutter and bearing shaft, which can result in sudden and almost total lubricant loss. U.S. Pat. No. 4,516,641, to Burr; U.S. Pat. No. 4,666,001, to Burr; U.S. Pat. No. 4,753,304, to Kelly; and U.S. Pat. No. 4,923,020 to Kelly, are examples of rigid face seals for use in earth-boring bits. Rigid face seals substantially improve the drilling life of earth-boring bits of the rolling cutter variety. Earth-boring bits with rigid face seals run with lower sliding friction relative to o-ring seals and are typically used in high speed and/or more challenge drilling applications, such as abrasive formations and high temperature wells, thus operate efficiently longer than prior-art bits.

Because the seal faces of rigid face seals are in constant contact and slide relative to each other, the dominant mode of failure of the seals is wear. Eventually, the seal faces become galled due to adhesive wear and the coefficient of friction between the seal faces increases, leading to increased operating temperatures, reduction in seal efficiency, and eventual seal failure, which ultimately result in bit failure. In an effort to minimize seal wear, seal rings of prior-art rigid face seals are constructed of tool steels such as 440C stainless, or hardened alloys such as Stellite. Use of these materials in rigid face seals lengthens the drilling life of the bit, but leaves room for improvement of the drilling longevity of rigid face seals, and thus earth-boring bits.

Hard coatings on the face of the seal can increase the life of the seal. The hard coatings, which often contain natural or synthetic diamonds or other alloys, can be very expensive. Some seals have employed a textured surface which can reduce friction and surface temperatures associated with the seal. Methods of creating a texture on a hard coating require a relatively thick, and thus expensive, hard coating. Furthermore, the relatively thick hard coating requires the underlying rigid face seal to be somewhat less thick than an un-coated seal. A thick coating can also change the stiffness of the seal which may not be desirable. A need exists, therefore, for a rigid face seal with a hard coating and a texture, wherein the hard coating is very thin.

A need exists, therefore, for a rigid face seal for use in earth-boring bits having improved wear-resistance and reduced coefficients of sliding friction between the seal faces.

### SUMMARY OF THE INVENTION

In an exemplary embodiment of the present invention, a thin-film coating with a textured surface is formed on a seal face of a rigid sealing ring for use in an earth boring drill bit. In some embodiments, a thin-film coating with a textured surface is formed on two or more sealing rings for use in an earth boring drill bit.

The textured surface may be first formed on the rigid sealing ring itself, by any technique such as mechanical techniques, chemical etching, or laser machining The textured surface may comprise pores having a diameter of, for example, 100 microns. Furthermore, the pores may have a depth of, for example, 5-7 microns.

A thin-film coating may be applied on the surface of the rigid sealing ring or rings. The thin-film coating may be a hard coating, such as diamond-like carbon or AIMgB₁₄. The thin-film coating may be applied by a variety of techniques, such as plasma-assist physical vapor deposition, chemical vapor deposition, or pulsed laser deposition. The thin-film coating may be very thin, with a thickness of, for example, 1-5 microns. The pore density may be 20-30 percent. Due to the thin nature of the coating, the texture on the seal face is present through the coating, thus giving the coating a textured surface.

In an alternative embodiment, the thin-film coating may be applied to a smooth or a textured surface on the rigid sealing ring. A texture may be applied to the thin-film coating by, for example, using a laser to create a texture such as pores in the coating. In some embodiments, the pores may be 100 microns in diameter, 5-7 microns deep, and have a pore density of 20-30 percent. In some embodiments, the depth of the pores is greater than the thickness of the coating, thus exposing the rigid seal face through the coating.

The texture promotes hydrodynamic pressure, lowers face torque and temperature, and traps wear debris and the thin hard coating protects the texture from being worn out from the asperity contact.

### BRIEF DESCRIPTION OF THE DRAWINGS

FIG. 1 is a fragmentary section view of a section of an earth-boring drill bit in an exemplary embodiment of the present invention.

FIG. 2 is an enlarged, fragmentary section view of a seal assembly for use with the earth boring bit of FIG. 1 according to an exemplary embodiment of the present invention.

FIG. 3 is an enlarged, fragmentary section view of an alternative seal assembly contemplated for use with an exemplary embodiment of the present invention.

FIG. 4 is a partial top view of a rigid ring of the earth-boring bit of FIG. 1.

FIG. 5 is a perspective view of an exemplary embodiment of the application of texture to a rigid ring of the earth-boring bit of FIG. 1.

FIG. 6 is a partial sectional view of a rigid ring of the earth-boring bit of FIG. 1.

FIG. 7 is a diagrammatic view of the plasma-assisted chemical vapor deposition coating of a rigid ring of the earth-boring bit of FIG. 1.

FIG. 8 is a partial sectional view of an alternative embodiment of the rigid ring of the earth-boring bit of FIG. 1.

### DETAILED DESCRIPTION

Although the following detailed description contains many specific details for purposes of illustration, one of ordinary skill in the art will appreciate that many variations and alterations to the following details are within the scope and spirit of the invention. Accordingly, the exemplary embodiments of the invention described herein are set forth without any loss of generality to, and without imposing limitations thereon, the present invention.

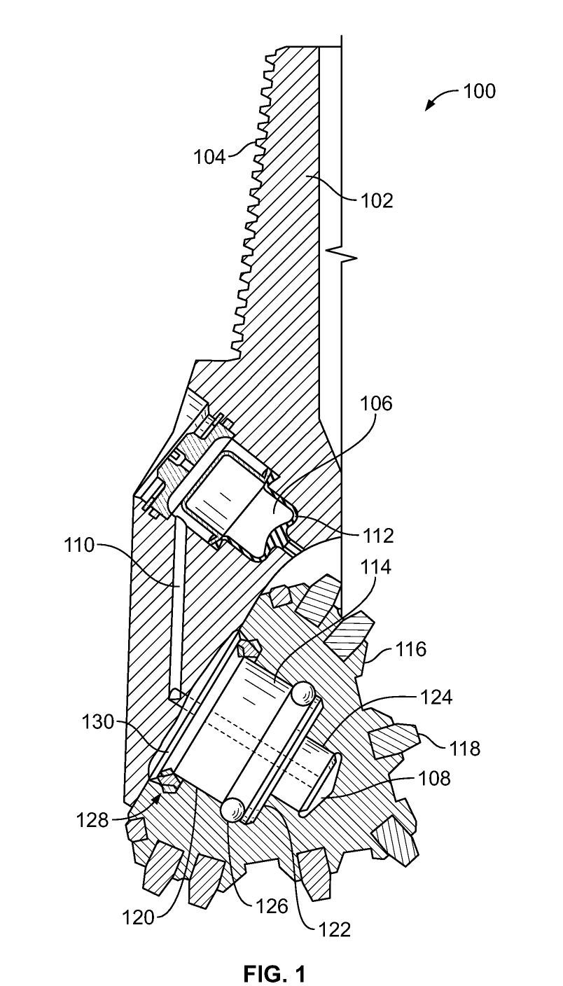

FIG. 1 depicts, in a fragmentary section view, one section of an earth-boring bit 100 according to the present invention. Earth-boring bit 100 is provided with a body 102, which is threaded at its upper extent 104 for connection into a drillstring (not shown).

Earth-boring bit 100 is provided with a pressure compensating lubrication system 106. Pressure compensating lubrication system 106 is vacuum pressure filled with lubricant at assembly. The vacuum pressure lubrication process also ensures that the journal bearing cavity generally designated as 108 is filled with lubricant through passage 110. Ambient borehole pressure acts through diaphragm 112 to cause lubricant pressure to be substantially the same as ambient borehole pressure.

A cantilevered bearing shaft 114 depends inwardly and downwardly from body 102 of earth-boring bit 100. A generally frusto-conical cutter 116 is rotatably mounted on cantilevered bearing shaft 114. Cutter 116 is provided with a plurality of generally circumferential rows of inserts or teeth 118, which engage and disintegrate formation material as earth-boring bit 100 is rotated and cutters 116 roll and slide along the bottom of the borehole.

Cantilevered bearing shaft 114 is provided with a cylindrical bearing surface 120, a thrust bearing surface 122, and a pilot pin bearing surface 124. These surfaces 120, 122, 124 cooperate with mating bearing surfaces on cutter 116 to form a journal bearing on cantilevered bearing shaft 114 on which cutter 116 may rotate freely. Lubricant is supplied to journal bearing through passage 110 by pressure-compensating lubricant system 106. Cutter 116 is retained on bearing shaft 114 by means of a plurality of precision-ground ball locking members 126.

A seal assembly 128 according to the present invention is disposed proximally to a base 130 of cantilevered bearing shaft 114 and generally intermediate to cutter 116 and bearing shaft 114. This seal assembly is provided to retain the lubricant within bearing cavity 108, and to prevent contamination of lubricant by foreign matter from the exterior of bit 100. The seal assembly may cooperate with pressure-compensating lubricant system 106 to minimize pressure differentials across seal 128, which can result in rapid extrusion of and loss of the lubricant, as disclosed in U.S. Pat. No. 4,516,641, to Burr. Thus, pressure compensator 106, with diaphragm 112, compensates the lubricant pressure for hydrostatic pressure changes encountered by bit 100, while seal assembly 128 compensates for dynamic pressure changes in the lubricant caused by movement of cutter 116 on shaft 114.

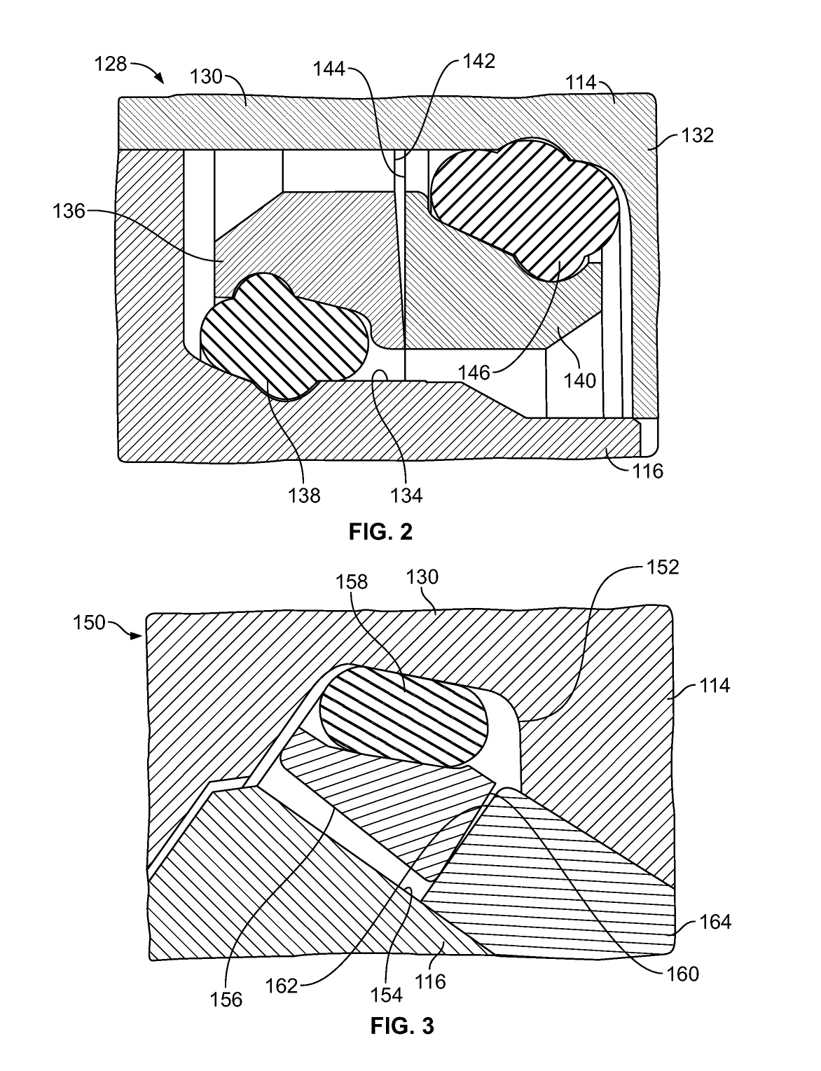

FIG. 2 depicts, an enlarged section view, a preferred seal configuration 128 contemplated for use with the present invention. Seal assembly 128 illustrated is known as a “dual” rigid face seal because it employs two rigid seal rings, as opposed to the single-ring configuration (not shown). Dual rigid face seal assembly 128 is disposed proximally to base 130 of bearing shaft 114 and is generally intermediate to cutter 116 and shaft 114. Seal assembly 128 is disposed in a seal groove defined by shaft groove 132 and cutter groove 134. Dual rigid face seal assembly 128 comprises a cutter rigid ring 136, a cutter resilient energizer ring 138, rigid seal ring 140, and shaft resilient energizer ring 146. Cutter rigid seal ring 136 and shaft rigid seal ring 140 are provided with precision-formed radial seal faces 142, 144, respectively. Rigid seal rings 136 and 140 may be made of any of a variety of materials including, for example, stainless steel such as 440C. Resilient energizer rings 138, 146 cooperate with seal grooves 132, 134 and rigid seal rings 136, 140 to urge and maintain radial seal faces 142, 144 in sealing engagement. The seal interface formed by seal faces 142, 144 provides a barrier that prevents lubricant from exiting the journal bearing, and prevents contamination of the lubricant by foreign matter from exterior of bit 100.

FIG. 3 illustrates, in enlarged section view, an alternative seal configuration 150. Seal assembly 150 comprises shaft seal groove 152, cutter seal groove 154, rigid seal ring 156, and resilient energizer ring 158. Rigid seal ring may be made of any of a variety of materials including, for example, stainless steel such as 440C. A precision-formed radial seal face 160 is formed on rigid seal ring 156, and mates with a corresponding precision-formed seal face 162 carried by cutter 116. Seal face 162 is formed on a bearing sleeve 164 interference fit in cutter 116. Resilient energizer ring 158 cooperates with shaft seal groove 152 and rigid seal ring 156 to urge and maintain seal faces 160, 162 in sealing engagement.

At least a portion, and preferably the entirety, of seal faces 160, 162 of seal assembly 150 is formed of super-hard material having a coefficient sliding friction less than that of the material of rigid seal ring 156. Exemplary dimensions for the seal assembly depicted in FIG. 3 may be found in U.S. Pat. No. 4,753,304 to Kelly.

The seal assemblies depicted in FIGS. 1, 2, and 3 are representative of rigid face seal technology and are shown for illustrative purposes only. The utility of the present invention is not limited to the seal assemblies illustrated, but is useful in all manner of rigid face seals. Other types of rigid seal rings with dynamic engagement surfaces may be used. Different configurations of seals within various types of earth-boring bits may be used.

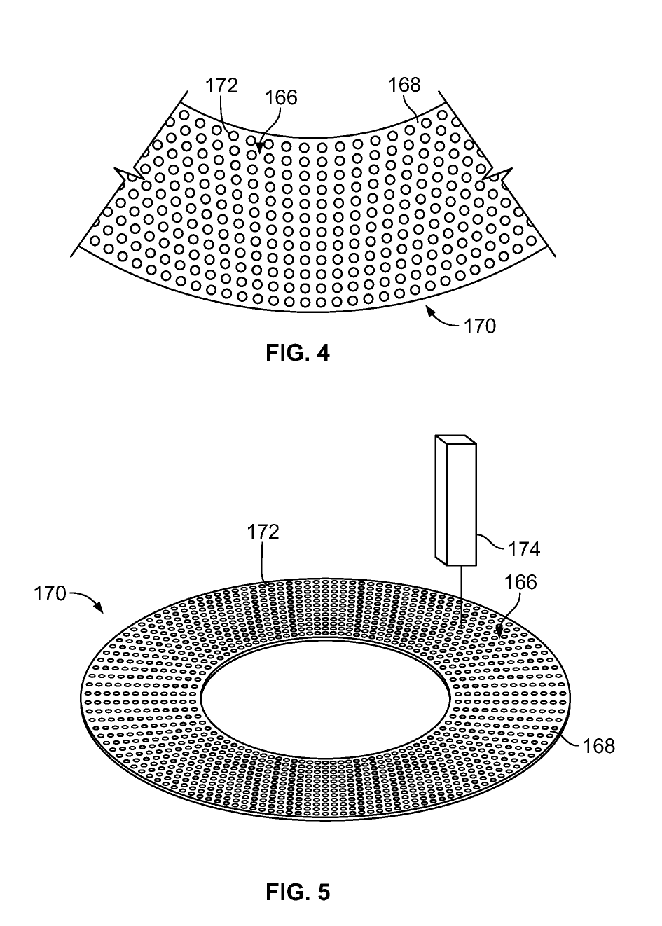

Referring to FIG. 4, a textured surface 166 is created on surface 168 of rigid ring 170. The textured surface may be created on both cutter rigid ring 136 (FIG. 2) and shaft rigid ring 140 (FIG. 2), or may be created on one but not the other. The following descriptions refer to texturing and coating rigid ring 170, which may be any rigid seal ring or sealing thrust washer. The rigid ring 170 described may be cutter rigid ring 136, shaft rigid ring 140, rigid seal ring 156, or a rigid ring used in other applications (not shown) requiring a rigid seal ring.

Textured surface 166 may be a plurality of recesses, such as round indentations, or pores 172, on surface 168 of rigid ring 170. In an exemplary embodiment, each pore 172 has a generally round shape having a diameter of roughly 100 micrometers (“microns”) and a depth of roughly 5-20 microns. In some embodiments, pores 172 have a depth of roughly 5-7 microns. The pore 172 diameter may be larger or smaller, and the depth may be larger or smaller. The pores need not be uniform or homogenous. In some embodiments, pores 172 on a single rigid ring 170 may have different diameters or depths. In alternative embodiments (not shown), texturing may be other shapes such as, for example, square indentations, elliptical indentations, and the like.

In embodiments using pores 172 such as round pores, the pore density may be roughly 20-30%, but any pore density may be used. Pore density refers to the percentage of the surface area of the seal face that is occupied by the pores. Thus if, for example, the pore density equals 30%, then 70% of the surface will contact a mating smooth surface. Some embodiments may use a lower pore density, such as roughly 10-20%, while other embodiments may use a higher pore density, such as roughly 30-60%.

Testing has shown that a 100 micron diameter pore, with an average depth of 5 microns and a 20% pore density produced the least amount of galling on the surface of the rigid seal. Pore diameters of 50 and 100 microns were tested. Pore depths of 3, 5, and 7 microns were tested. Pore densities of 10%, 20%, and 30% were tested. The test rings having 100 micron pore diameters, 5-7 micron pore depths, and 20-30% pore density showed the least wear. The test samples with smaller diameter pores, 10% pore density, or 3 micron pore depth showed increased wear and galling.

Referring to FIG. 5, in an exemplary embodiment, textured surface 166 is created on surface 168 of rigid ring 170 with a picosecond pulse laser having a power of 0.5 mJ/pulse in 12 picosecond. In an exemplary embodiment, a high-repetition-rate picosecond Nd:YVO₄ laser 174 is used to cold-ablate material from the surface 168 of rigid ring 170. The short duration of the picosecond pulse is able to remove a desired amount of material without damaging surrounding material. Thus the pico-second pulse laser 174 is able to create the precise geometry required for the texture such as a pore 172. Other types of lasers 174 may be used to create the texture pattern on the surface 168 of rigid ring 170. Furthermore, other methods of creating recesses may be used, such as, for example, chemical etching, reactive ion etching, embossing, vibro-rolling, or vibro-mechanical texturing may be used, provided that the other methods (not shown) are able to create micro-sized recesses, such as a 100 micron diameter pore 172, without adversely changing material properties surrounding the pore 172. In some embodiments, post polishing may be used to remove extruded material from the edge of the pores.

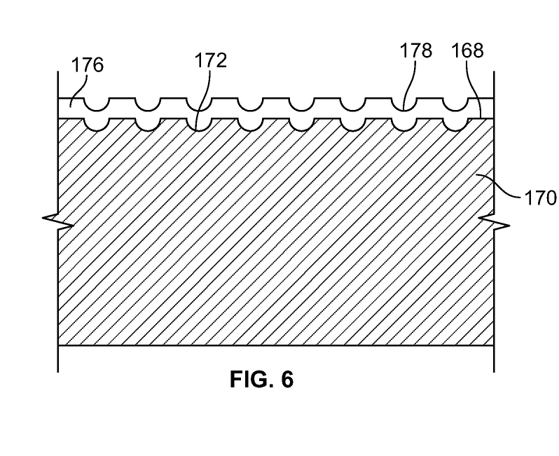

Referring to FIG. 6, thin film coating (“coating”) 176 can be applied to one or more surfaces 168 of rigid ring 170 after the pores 172 have been created. Coating 176 may be applied to all surfaces 168 of rigid ring, or just to the seal face or surfaces that will slidingly engage a mating surface. Coating 176 may be a super hard coating.

Coating 176 may be a super hard coating, as defined below, applied over the textured surface 166 of FIG. 4. The coating has the function of protecting the textured surface from wear due to sliding contact. After application, the thin film coating 176 presents the texture of surface 166 on the exterior of coating. Thus pores 172 are present as coating pores 178. If the coating 176 is too thick, the coating would tend to fill in the pores 172 and thus present a smooth surface rather than presenting the texture of the underlying textured surface 166. A sufficiently thin coating 176, with a thickness in the 1-5 micron range, and preferably less than 10 microns, is able to assume the texture of the underlying surface.

Coating 176 may be harder and more lubricious than the substrate. In some embodiments, a hard coating such as diamond-like carbon (“DLC”) is applied to a textured surface on a stainless steel substrate. Such coating is described in U.S. Pat. No. 7,234,541. In other embodiments, an alloy of boronaluminum-magnesium such as, for example, AIMgB₁₄, or any other super hard material can be used to form the hard coating over the textured substrate surface. Super hard materials (as the term is used herein) have micro-hardnesses in the vicinity of 5000 and upward on the Knoop scale and are to be distinguished from ceramics such as silicon carbide, aluminum oxide, or cermet such as tungsten carbide, and the like, which have micro-hardnesses of less than 3000 on the Knoop scale. The Knoop micro-hardness value should be determined according to ASTM C849, C1326 and E384 test methods. In addition to their hardness and resulting wear resistance, super-hard materials, particularly the diamond variants such as crystalline or nanocrystalline diamond coatings, have generally good-to-excellent properties in sliding friction and heat dissipation, especially acting as a friction pair. In another embodiment, ceramic or cermet material which has a hardness value greater than that of quartz is used as a protective coating for the textured surface.

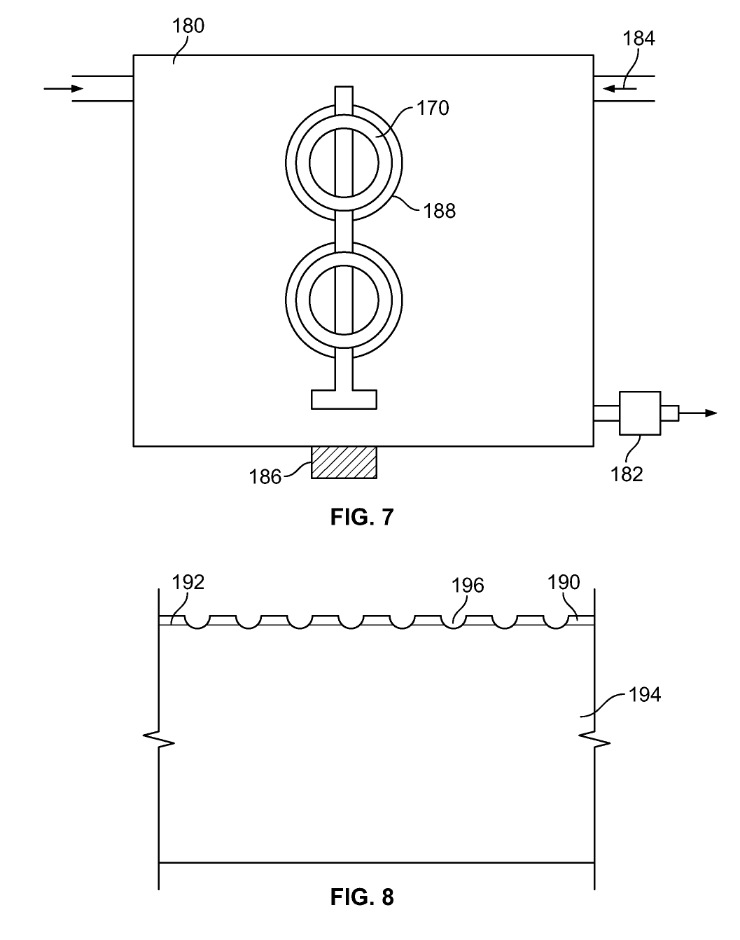

Referring to FIG. 7, coating 176 (FIG. 6) may be applied to surface 168 of rigid ring 170 in any variety of ways. Coating may be applied by physical vapor deposition (“PVD”), chemical vapor deposition (“CVD”), plasma-assist chemical vapor deposition (“PACVD”), or pulsed laser deposition. In an exemplary embodiment, DLC is applied to rigid ring 170 by PACVD.

As one of ordinary skill in the art will appreciate, to create a coating on rigid ring 170 using PACVD technique, rigid ring is placed in chamber 180. Chamber 180 is pumped down by vacuum source 182 to create negative pressure within chamber 180. Chemical vapor 184 containing chemicals for coating flows into chamber 180. A radio frequency (“RF”) source 186 is used to strike plasma within the chamber. Plasma sheath 188 forms on the surface of rigid ring 170 during the reaction. Plasma sheath 188 assists the chemical reactions and deposition required to create coating 176 (FIG. 6) on rigid ring 170.

Referring back to FIG. 6, in an exemplary embodiment, coating 176 is between approximately 1 micron and approximately 5 microns thick. Coating 176 may be thinner or thicker. In an exemplary embodiment, the thickness of the coating 176 does not significantly alter the dimensions of the rigid ring 170. In other words, the coating 176 is so thin that the dimensions of rigid ring are virtually identical to the dimensions of an uncoated rigid ring (not shown). Thus the user may maintain a single type of rigid ring in inventory and have the option of having some of the single type of rigid ring coated. Furthermore, the coated and uncoated types of rigid ring may be used interchangeably in an application such as in an earth boring drill bit 100 (FIG. 1).

Referring to FIG. 8, in an alternative embodiment, thin coating 190 is a hard coating that may be created on untextured surface 192 of rigid ring 194, and then texture such as pores 196 may be applied to thin coating 190. In this alternative embodiment, coating 190 may be applied in any of the manners described above, including PVD, CVD, PACVD, and laser deposition. As described above, coating 190 may be roughly 1-25 microns thick, but can be thicker or thinner.

In an exemplary embodiment, coating 190 may be applied to rigid ring 194 having a generally smooth surface 192, thus causing thin coating 190 to have a generally smooth surface after deposition. Then pores 196 may be created by laser etching pores 196 into coating 190. In this embodiment, a picosecond pulsed laser 174 (FIG. 5) may be used to laser etch or laser ablated pores 196 into coating. Other techniques may be used to create pores 196, such as chemical etching, reactive ion etching, embossing, vibro-rolling, or vibro-mechanical texturing may be used, provided that the technique used is suitable for the hardness of coating 190. Pores 196 may be any size and shape, including, for example, a round pore having a diameter of roughly 100 microns and a depth of roughly 5-20 microns.

In an exemplary embodiment, the pores 196 may extend completely through coating 190 and into the underlying surface of rigid ring 194. Thus the rigid ring 194 material, such as 440C steel, may be exposed through each of the pores 196.

The present invention has been described with reference to several embodiments thereof. Those skilled in the art will appreciate that the invention is thus not limited, but is susceptible to variation and modification without departure from the scope and spirit thereof. As used herein, recitation of the term about and approximately with respect to a range of values should be interpreted to include both the upper and lower end of the recited range.

As used in the specification and claims, the singular form “a”, “an” and “the” may include plural references, unless the context clearly dictates the singular form.

Although some embodiments of the present invention have been described in detail, it should be understood that various changes, substitutions, and alterations can be made hereupon without departing from the principle and scope of the invention.

We claim:

1. An apparatus for forming a dynamic seal against an adjacent surface, the apparatus comprising:
an annular seal body having a sealing face;
a hard coating deposited on the sealing face, the hard coating having a thickness of less than 10 microns; and
recesses on an exposed surface of the hard coating having depths in the range from 5-7 microns.

2. The apparatus of claim 1, wherein the recesses have depths greater than the depth of the hard coating.

3. The apparatus of claim 1, wherein the recesses have depths less than the depths of the hard coating.

4. The earth boring bit according to claim 1, wherein the recesses comprise pores having a diameter of 50 to 100 microns.

5. The earth boring bit according to claim 1, wherein the recesses have a density between 20% and 30%.

6. An earth boring bit comprising:
a bit body with at least one cantilevered bearing shaft that has a base and extends downwardly and inwardly from the bit body;
a cutter rotably mounted on the bearing shaft;
a seal assembly mounted between the cutter and the bearing shaft and having a rigid seal ring with a seal face having a thin film coating;
a hard coating on the seal face having a thickness less than 25 microns; and
recesses in the coating having depths in the range of from 5 to 20 microns.

7. The earth boring bit according to claim 6, wherein the hard coating is diamond like carbon (DLC).

8. The earth boring bit according to claim 6, further comprising a second rigid seal ring, the second rigid seal ring having a seal face with diamond like carbon coating having a thickness no greater than 5 microns and recesses having depths in the range from 5 to 7 microns, the seal face of the second rigid seal ring being in sliding engagement with the rigid seal ring.

9. The method according to claim 6, wherein a texture is created on the rigid seal ring before depositing the hard coating, and wherein the hard coating exhibits the texture after deposition.

10. The earth boring bit according to claim 6, wherein recesses have depths less than the thickness of the coating.

11. The earth boring bit according to claim 6, wherein the recesses comprise pores having a diameter of 50 to 100 microns.

12. The earth boring bit according to claim 6, wherein the recesses have a density between approximately 20% and approximately 30%.

13. The earth boring bit according to claim 6, wherein the pores have depths greater than the thickness of the coating.

14. A method for constructing a seal for an earth-boring bit, the method comprising:
forming at least one metallic rigid seal ring;
depositing a hard coating to the rigid seal ring, the hard coating having a thickness less than 50 microns;
creating a texture on the hard thin-film coating by forming recesses having a depth in the range of 5-20 microns;
mounting the rigid seal ring on the bearing shaft proximal to the base of the bearing shaft; and
mounting a cutter on the bearing shaft for rotation and in engagement with the rigid seal ring.

15. The method according to claim 14, where the coating comprises diamond like carbon.

16. The method according to claim 14, wherein the texture is formed by laser machining after the hard coating has been applied.

17. The method according to claim 14, wherein the hard coating has a thickness less than the depth of the recesses.

18. The method according to claim 14, wherein the hard coating has a thickness greater than the depth of the recesses.

19. The method according to claim 14, wherein the recesses comprise pores having a diameter of in the range from 50 to 100 microns.

20. The method according to claim 14, wherein the texture has a density between approximately 20 and approximately 30 percent.

21. A method for constructing a seal for an earth-boring bit, the method comprising:
forming at least one metallic rigid seal ring;
creating a texture on a surface of the seal ring; and
depositing a super hard coating to the surface of the seal ring after creating the texture, wherein the super hard coating exhibits the texture after deposition.
